(19) United States
(12) Patent Application Publication
(10) Pub. No.: US 2005/0142239 A1
(43) Pub. Date: Jun. 30, 2005

(54) Thermoforming tool

(75) Inventor: Matthias Frank, Nordheim (DE)

Correspondence Address: ROTHWELL, FIGG, ERNST & MANBECK, P.C., 1425 K STREET, N.W., SUITE 800, WASHINGTON, DC, 20005, US

(73) Assignee: Marbach Werkzeugbau GmbH, Heilbronn (DE)

(21) Appl. No.: 11/010,571

(22) Filed: Dec. 14, 2004

(30) Foreign Application Priority Data
Dec. 16, 2003 (DE) 203 19 530.2

(51) Int. Cl. B29C 43/52

(52) U.S. Cl. 425/398

(57) ABSTRACT

A thermoforming tool for producing cup-shaped molded parts from a heated film of plastic includes an upper tool and a lower tool, which are movable in relation to each other for clamping the film of plastic therebetween. At least one mold cavity for forming a molded part from the film of plastic is formed in the lower tool and at least one prestretching structure movable into a corresponding mold cavity is arranged in the upper tool inside a hold-down device. The prestretching structure includes at least two prestretching levers pivotable about an associated pivot axis, which lies in a plane running perpendicularly to the direction of movement of the prestretching structure. Each of the prestretching levers has a stretching arm extending downward, and a stop arm extending upward. On the inner surface of the hold-down device a guiding projection is formed opposite to a corresponding one of the prestretching levers, the stretching arm sliding on the guiding projection during movement of the prestretching structure into the mold cavity in such a way that the stretching arm is pivoted outward.

### FIELD OF THE INVENTION

The invention relates to a thermoforming tool for producing cup-shaped molded parts from a heated film of plastic, comprising an upper tool and a lower tool, which are movable in relation to each other for clamping the film of plastic between them, at least one mold cavity for the forming of a molded part from the film of plastic being formed in the lower tool, and at least one prestretching means which can be moved into a corresponding mold cavity being arranged in the upper tool inside a hold-down device.

### DESCRIPTION OF THE BACKGROUND ART

Such a thermoforming tool is known from, inter alia, EP 1 103 365 A1. The known thermoforming tool comprises an upper tool and a lower tool, which are movable in relation to each other in order to clamp the heated film of plastic between them. Arranged on the upper tool, inside a hold-down device, is a prestretching device, which is fastened to the lower end of a rod which is displaceably mounted coaxially in the upper tool and is connected to a drive. For molding the molded part, the prestretching device is moved into the mold cavity, coming to bear against the heated film of plastic and pressing the latter downward into the mold cavity. Subsequently, forming air is introduced through an air duct provided in the prestretching device, for which reason the film of plastic comes to lie against the inner surface of the mold cavity. The contact with the cooled mold cavity walls has the effect that the thermoformed film of plastic cools down and becomes dimensionally stable.

The end face of the prestretching device that comes into contact with the film of plastic is relatively large, in order to achieve suitable pre-deformation of the film of plastic before the molding air is introduced. However, the film of plastic is cooled on the end face of the prestretching device, so that in the pre-deformation by the prestretching device the film of plastic is stretched to a lesser extent in the region of the end face of the prestretching device than in the region results in an uneven wall distribution, and in particular a considerable wall thickness in the bottom region of the container to be molded.

### SUMMARY OF TH E INVENTION

The the object of the invention is to provide a thermoforming tool which makes it possible to produce molded parts with uniform wall distribution and small wall thickness.

This object is achieved according to the invention by a thermoforming toolfor producing cup-shaped molded parts from a heated film of plastic, comprising an upper tool and a lower tool, which are movable in relation to each other for clamping said film of plastic between them, at least one mold cavity for forming of a molded part from the film of plastic being formed in the lower tool, and at least one prestretching means which can be moved into a corresponding mold cavity being arranged in the upper tool inside a hold-down device, wherein said prestretching means comprises at least two prestretching levers pivotable about an associated pivot axis, which lies in a plane running perpendicularly to the direction of movement of said prestretching means, each of said prestretching levers has a stretching arm extending downward, and a stop arm extending upward, and on the inner surface of said hold-down device a guiding projection is formed opposite to a corresponding one of said prestretching levers, said stretching arm sliding on said guiding projection during movement of said prestretching means into said mold cavity in such a way that said stretching arm is pivoted outward.

Preferably a contact element with a convex contact area which comes into contact with the film of plastic when there is movement of the prestretching mechanism into the mold cavity is arranged at the free end of the stretching arm.

Advantageously the mold cavity has a polygonal cross section, and a prestretching lever is respectively assigned to a corner of the mold cavity.

In a preferred embodiment the mold cavity has a rectangular cross section.

In the case of the thermoforming tool according to the invention, the film of plastic is stretched outward from the bottom region in a specific manner by the prestretching lever and is available for side wall distribution. A movement into a respective corner of a molded part of polygonal cross section allows sufficient material to be brought into the corner for this region of the molded part also to have the necessary wall thickness.

### BRIEF DESCRIPTION OF THE DRAWINGS

An exemplary embodiment of the invention is explained in more detail below on the basis of drawings, in which:

FIG. 1 shows a longitudinal section through a mold device of a thermoforming tool according to the invention, in the region of two prestretching levers, a prestretching mechanism being located in a starting position;

FIG. 2 shows the mold device from FIG. 1, the prestretching mechanism being located in an intermediate position;

FIG. 3 shows the mold device from FIG. 1, the prestretching mechanism being located in an end position;

FIG. 4 shows the mold device from FIG. 1, the prestretching mechanism being located in an end position and molding air being introduced.

### DESCRIPTION OF THE BACKGROUND ART

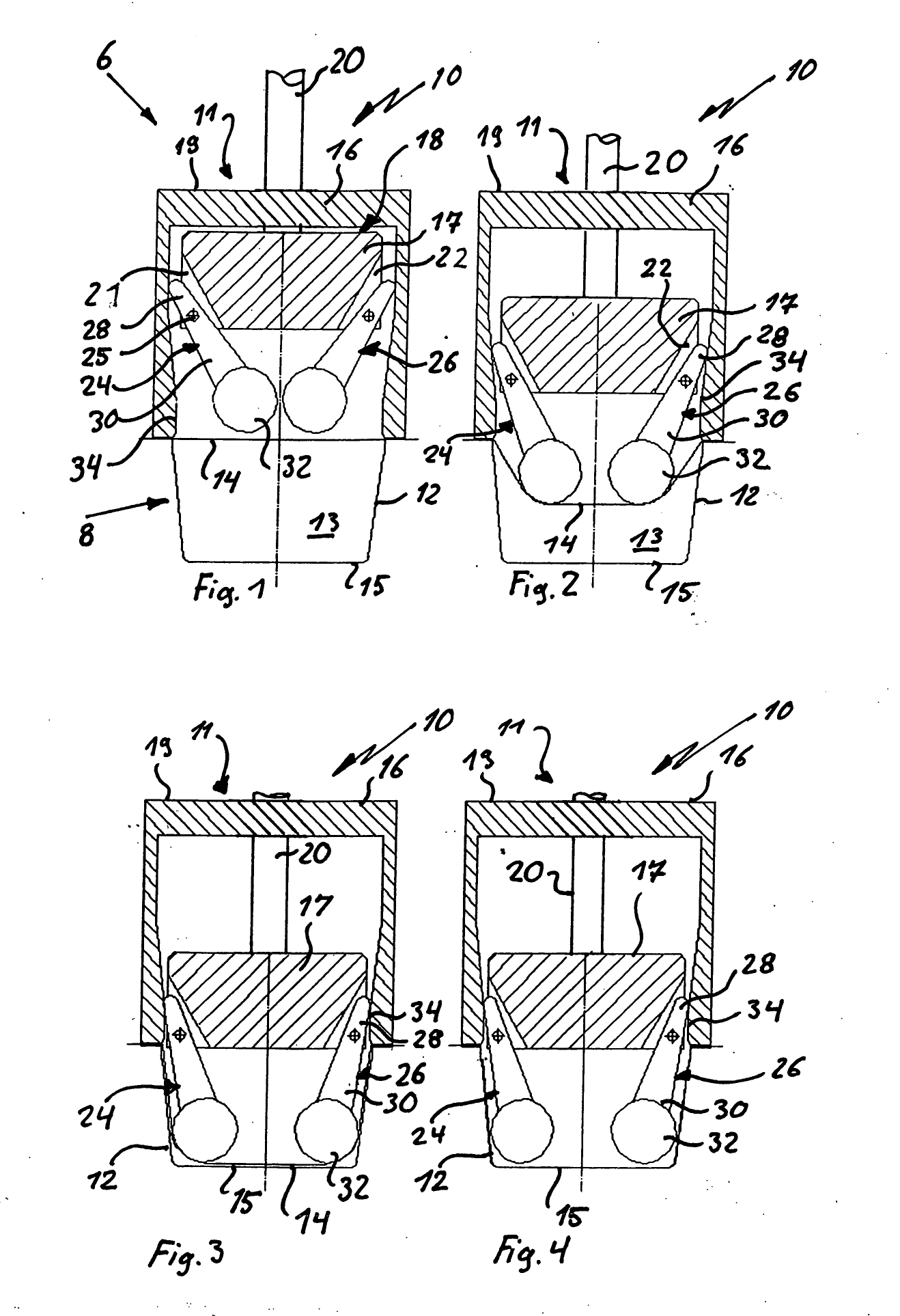

A thermoforming tool 10 has an upper tool 6 and a lower tool 8, which are movable in relation to each other in order to clamp a film of plastic 14 between them. The thermoforming tool 10 comprises a number of mold devices 11, only one of which is shown in FIGS. 1 to 4. The mold devices 11 serve in each case for forming a molded part of a rectangular cross section.

The mold device 11 comprises a pot-shaped, downwardly open hold-down device 16, which is arranged in the upper tool 6 and has a substantially rectangular cross section perpendicularly to the plane of the drawing. A prestretching mechanism 18 is movably arranged coaxially inside the hold-down device 16. The prestretching mechanism 18 comprises a likewise cross-sectionally substantially rectangular carrier body 17, which is connected on its upper side to a prestretching rod 20 which passes through the upper end plate 19 of the hold-down device 16 and is movable coaxially in relation to the hold-down device 16 by a drive (not shown).

Inserted in the lower tool 8 underneath the hold-down device 16 is a mold insert 12, in which there is formed a cross-sectionally substantially rectangular mold cavity 13 for the forming of a molded part, which is bounded in the downward direction by a mold base 15, which is fastened in a known way to an ejector rod (not shown).

Formed in the lower region of each of the four corners of the carrier body 17 are recesses 21, 22, which are triangular when seen in longitudinal section. A prestretching lever 24, 26 is respectively mounted pivotably about a pivot axis 25 in these recesses 21, 22. A total of four prestretching levers 24, 26 are provided, only two of which are shown in FIGS. 1 to 4.

Each prestretching lever 24, 26 has a stop arm 28, which extends upward with respect to the pivot axis 25, and also a prestretching arm 30, which extends downward beyond the carrier body 17 and to the lower free end of which a spherical contact element 32 is attached. The prestretching levers 24, 26 are respectively biased, for example by a torsion spring, in such a way that the stop arm 28 bears with its outer free end against the inside wall of the hold-down device 16.

In the starting position shown in FIG. 1, in which the carrier body 17 is adjacent the end plate of the hold-down device 16, the contact elements 32 are arranged symmetrically in relation to each other with very little distance between them and are located just above the film of plastic 14. On the inner side of the side wall of the hold-down device 16, in the lower region, guiding projections 34 are respectively arranged lying opposite the corresponding prestretching lever 24, 26. The height of the guiding projections 34 increases steadily at first in the direction of the lower tool 8. This is followed by an end portion of constant height.

For the molding of a molded part, the carrier body 17 is moved downward by means of the drive and the prestretching rod 20, so that the contact elements 32 come into contact with the film of plastic 14. As this happens, the stop arms 28 slide along the guiding projections 34. On account of the slope of the guiding projections 34, the stop arms 28 are moved inward, and consequently the stretching arms 30 with the contact elements are moved downward. The prestretching levers 24, 26 are thereby pivoted uniformly and, in the lowermost end position, shown in FIG. 3, the contact elements 32 are in the direct proximity of the corresponding corner of the mold cavity 13.

On account of the the downwardly and outwardly directed movement of the contact elements 32, the film of plastic 14 is stretched uniformly in the side regions and in the bottom region. The contact area of the contact elements 32 is relatively small, so that the film of plastic 14 is not prematurely cooled in the bottom region. The film bears well against the convex contact area. Sufficient material gets into the corners of the mold cavity 13 for this region of the molded part also to have the necessary wall thickness.

Subsequently, forming air is introduced into the mold cavity 13 in a known way, so that the film of plastic 14 comes to bear against the inside wall of the mold attachment 12 and against the mold base 15. The film of plastic 14 cools down and becomes dimensionally stable. Then the upper tool 6 and the lower tool 8 are moved away from each other and the prestretching mechanism 18 is retracted into the hold-down device 16 again, into the starting position shown in FIG. 1. At the same time, the molded part that has been produced is ejected by moving out the mold base 15 fastened to the ejector rod.

1. A thermoforming tool for producing cup-shaped molded parts from a heated film of plastic, comprising an upper tool and a lower tool, which are movable in relation to each other for clamping said film of plastic therebetween, at least one mold cavity for forming a molded part from said film of plastic being formed in said lower tool and at least one prestretching means movable into a corresponding mold cavity being arranged in said upper tool inside a hold-down device, wherein
said prestretching means comprises at least two prestretching levers pivotable about an associated pivot axis, which lies in a plane running perpendicularly to the direction of movement of said prestretching means,
each of said prestretching levers has a stretching arm extending downward, and a stop arm extending upward, and
on the inner surface of said hold-down device a guiding projection is formed opposite to a corresponding one of said prestretching levers, said stretching arm sliding on said guiding projection during movement of said prestretching means into said mold cavity in such a way that said stretching arm is pivoted outward.

2. The thermoforming tool as claimed in claim 1, wherein a contact element having a convex contact area which comes into contact with said film of plastic when there is movement of said prestretching mechanism into said mold cavity is arranged at a free end of said stretching arm.

3. The thermoforming tool as claimed in claim 1, wherein said mold cavity has a polygonal cross section, and one of said prestretching levers is respectively associated to one corner of said mold cavity.

4. The thermoforming tool as claimed in claim 1, wherein said mold cavity has a rectangular cross section.
